(19) United States
(12) Patent Application Publication
(10) Pub. No.: US 2005/0039318 A1
(43) Pub. Date: Feb. 24, 2005

(54) Method for connecting an aluminum die-cast part to another part

(76) Inventors: Thomas Feis, St. Ingbert (DE); Jakob Schmitt, St. Ingbert (DE)

Correspondence Address: COLLARD & ROE, P.C., 1077 Northern Boulevard, Roslyn, NY, 11576-1696, US

(21) Appl. No.: 10/919,895

(22) Filed: Aug. 17, 2004

Related U.S. Application Data
(63) Continuation of application No. PCT/DE03/00191, filed on Jan. 24, 2003.

(30) Foreign Application Priority Data
Feb. 18, 2002 (DE) 102 06 851.8

(51) Int. Cl. B23P 11/00

(52) U.S. Cl. 29/512

(57) ABSTRACT

A method for connecting an aluminum die-cast part to another part. The aluminum die-cast part has a circular shoulder and a collar that projects upwards, whereas the other part comprises a flat contact piece that is designed to lie on the shoulder. The collar projects above the contact piece. The contact piece is pressed onto the shoulder by a deformation fo the collar, the collar being completely deformed about its circumference.

### CROSS-REFERENCE TO RELATED APPLICATIONS

This is a continuation under 35 U.S.C. §120 of International Application No. PCT/DE03/00191, filed on Jan. 24, 2003, which claims priority from German No. 102 06 851.8, filed on Feb. 18, 2002.

### BACKGROUND OF THE INVENTION

1. Field of the Invention

The invention relates to a method for connecting an aluminum die-cast part with another part.

2. The Prior Art

There is a method in which an aluminum die-cast part is connected with a sheet-metal part. This combined part is used in a gear mechanism. For this purpose, the aluminum die-cast part has a circular shoulder that has a diameter of approximately 15 cm, on which a contact piece of the sheet-metal part comes to rest. Furthermore, the aluminum die-cast part has a collar that is attached to the shoulder. This collar is braced at certain points, in order to press the contact piece onto the shoulder. In this connection, it can occasionally occur that the formed parts of the collar break off. This is particularly disadvantageous in gear mechanisms, because of possible additional functional problems that are connected with this. In order to prevent the braced regions of the collar from breaking out, it is known to pre-treat the aluminum die-cast part by means of an annealing process.

### SUMMARY OF THE INVENTION

It is therefore an object of the invention to improve the connection of an aluminum die-cast part with another part.

This task is accomplished, according to the invention, by a connection in which the collar is completely deformed around its circumference.

The parts of the collar that are deformed can thereby be prevented from breaking out, in advantageous manner. Furthermore, because the connection is made completely along the circumference of the circle, the connection is improved.

In one embodiment, the material of the aluminum die-cast part has a copper content of less than 2%. The copper content may be less than 1.2%.

It has been shown that the material of the aluminum die-cast part becomes more brittle with an increasing aluminum content, and this promotes breaking out of parts of the material. This can be advantageously avoided with the comparatively low copper content values described above. As compared with the widespread use of an alloy according to DIN 226, having a copper content between 2% and 3.5%, an alloy according to DIN 231 is therefore preferably used.

In another embodiment, the aluminum die-cast part consists of a GdAlSi₁₂Cu alloy. This has proven to be particularly advantageous with regard to its material properties.

In another embodiment, the other part is a sheet-metal part.

It is therefore advantageous that the two parts, made of different materials, can be connected with one another without great effort/expense.

In yet another embodiment, the collar of the aluminum die-cast part is deformed using a roller-burnishing tool.

In this way, the connection according to the present method can be produced in simple and advantageous manner. The material deformation can take place using the roller-burnishing tool, whereby only a comparatively low pressure has to be applied. The roller-burnishing tool consists of several rollers that are lowered onto the collar and deform the collar with a rotational movement along the circumference of the circle of the collar.

In a further embodiment, the collar of the aluminum die-cast part is deformed by means of a riveting process. In this connection, the process can be a staggered riveting process, for example.

In addition to the improved connection, from a technical point of view, there is furthermore a cost advantage in production, because the work step of annealing of the aluminum die-cast part can be eliminated.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows an aluminum die-cast part having a sheet-metal part resting on it, in cross-section, and

FIG. 2 shows the aluminum die-cast part having a sheet-metal part resting on it, in cross-section, after deformation of the collar.

### DETAILED DESCRIPTION OF THE PREFERRED EMBODIMENT

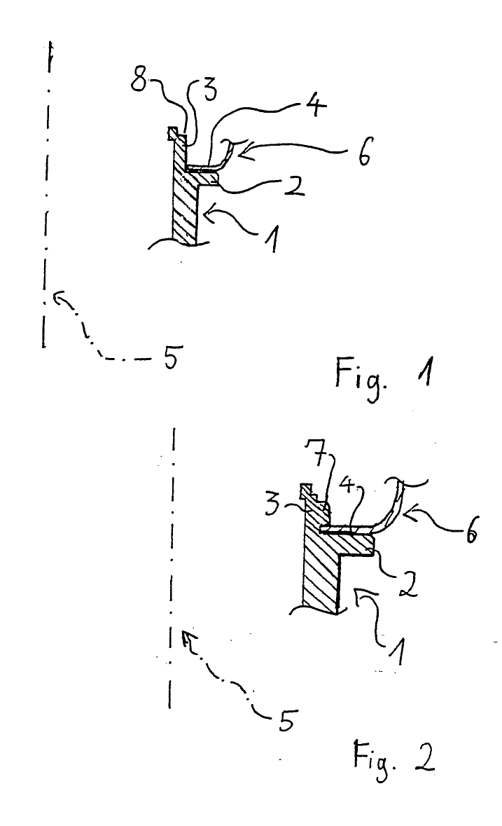

Referring now in detail to the drawings, FIG. 1 shows an aluminum die-cast part 1 in cross-section. In this connection, the aluminum die-cast part 1 is configured to be circular about a center axis 5. The aluminum die-cast part 1 has a shoulder 2 as well as a collar 3. In comparison with the size of the aluminum die-cast part 1 as shown, in cross-section, the radius is shown reduced in size, because of the distance of the center axis 5 from the cross-sectional representation of the aluminum die-cast part 1.

The radius can be, for example, 5 cm to 10 cm. The height of the part of the aluminum die-cast part as shown can be 1 cm, for example.

A contact piece 4 comes to rest on shoulder 2 of aluminum die-cast part 1. This contact piece 4 is flat, so that collar 3 stands higher than contact piece 4. Contact piece 4 is an integral part of another part 6, which can be formed from a different material. This material can be sheet metal, for example. The other part 6 is also configured to be circular, at least in the region of contact piece 4, so that the contact piece rests on the entire circumference on shoulder 2 of aluminum die-cast part 1.

A roller-burnishing tool can be set onto top 8 of collar 3 of aluminum die-cast part 1. The rollers of this roller-burnishing tool are rolled along the circumference of the circle and collar 3 is deformed on its entire circumference in the region of the circumference. By means of this deformation of collar 3, contact piece 4 of part 6 is firmly pressed onto shoulder 2 of aluminum die-cast part 1.

Instead of the deformation using the roller-burnishing tool, a riveting process, for example a staggered riveting process, can also be used.

In this way, aluminum die-cast part 1 is connected with the other part 6.

FIG. 2, analogous to the representation in FIG. 1, shows an aluminum die-cast part 1 with another part 6. In this connection, identical parts are provided with the same reference numbers that were also used in connection with FIG. 1.

Because of the deformation of collar 3, it can be seen that contact piece 4 of part 5 is wedged in place between shoulder 2 and deformed collar 3 of aluminum die-cast part 1.

In order to prevent the aluminum die-cast part from being too brittle and thereby the possibility of parts breaking off during deformation, it has been proven to be advantageous to provide a copper content that is not greater than 2% and advantageously lies below 1.2%. This can be achieved, for example, with a material according to DIN 231. It is advantageous if the aluminum die-casting material consists of a GdAlSi₁₂Cu alloy.

In the present invention, it is advantageous if the deformation of collar 3 is be achieved with comparatively low forces at which pressure on the material has to be exerted. In this way, the dimensional stability of precision-manufactured parts is not impaired.

Because the present method is able to advantageously prevent parts of the material from breaking out during the deformation, the method can be advantageously used to connect parts of a gear mechanism, such as the gear mechanism housing, with one another. Here, if parts come loose, this can result in more serious impairments of function, if loose parts impair the function of the gear mechanism when they get inside it.

Accordingly, while only a few embodiments of the present invention have been shown and described, it is obvious that many changes and modifications may be made thereunto without departing from the spirit and scope of the invention.

1. A method for connecting an aluminum die-cast part with another part, wherein the aluminum die-cast part has a circular shoulder and a collar that projects upward, wherein the other part has a flat contact piece for contact on the shoulder, wherein the collar projects upward beyond the contact piece, the method comprising:
pressing the contact piece onto the shoulder by deforming the collar, the collar being deformed along its entire circumference by rollers of a roller-burnishing tool, whereby on the side of the collar facing the contact piece, the contact piece is clamped by flowing of the material of the collar, and the side of the collar facing away from the contact piece retains the shape of the collar.

2. Method according to claim 1, wherein the aluminum die-cast part has a copper content of less than 2%.

3. Method according to claim 2, wherein the copper content is less than 1.2%.

4. Method according to claim 1, wherein the aluminum die-cast part consists of a GdAlSi₁₂Cu alloy.

5. Method according to claim 1, wherein said another part is a sheet-metal part.

6. Method according to claim 1, wherein the collar of the aluminum die-cast part is deformed using a roller-burnishing tool.

7. Method according to claim 1, wherein the collar of the aluminum die-cast part is deformed by means of a riveting process.
